(19) United States
(12) Patent Application Publication
(10) Pub. No.: US 2024/0238754 A1
(43) Pub. Date: Jul. 18, 2024

(54) ANION-DOPED METAL OXIDE

(71) Applicant: SINGAPORE UNIVERSITY OF TECHNOLOGY AND DESIGN, Singapore (SG)

(72) Inventors: Ping WU, Singapore (SG); A.J.M. Hasanthi Lakshika SENEVIRATHNA, Singapore (SG)

(21) Appl. No.: 18/547,589

(22) PCT Filed: Feb. 24, 2022
(86) PCT No.: PCT/SG2022/050090

§ 371 Date: Aug. 23, 2023

(30) Foreign Application Priority Data
Feb. 25, 2021 (SG) 10202101959P

(51) Int. Cl. B01J 20/04; B01D 53/62; B01D 53/81; B01J 20/28; B01J 20/30; C01F 5/08

(52) U.S. Cl. CPC B01J 20/041; B01D 53/62; B01D 53/81; B01J 20/045; B01J 20/046; B01J 20/048; B01J 20/28016; B01J 20/3007; B01J 20/3021; B01J 20/305; B01J 20/3078; C01F 5/08; B01D 2251/402; B01D 2257/504; B01D 2258/06; C01P 2002/52; C01P 2002/72; C01P 2004/03

(57) ABSTRACT

The present disclosure relates to a material comprising an oxide of an alkaline earth metal, wherein the oxide of the alkaline earth metal is doped with an anion. In particular embodiments, the material comprises MgO doped with an anion selected from the group consisting of chloride, sulfate, phosphate and any mixtures thereof. The present disclosure also relates to a method for preparing the material, a method for adsorbing CO2 from an environment and the use of the material to adsorb CO2 from an environment.

This application is the U.S. national phase of International Application No. PCT/SG2022/050090 filed Feb. 24, 2022, which designated the U.S. and claims priority to SG Patent Application No. 10202101959P filed Feb. 25, 2021, the entire contents of each of which are hereby incorporated by reference.

### TECHNICAL FIELD

This invention is related to the field of materials engineering, specifically in the development of an electrospun anion-doped metal oxide sorbent, wherein the sorbent is used at room temperature for capturing CO₂ from air.

### BACKGROUND ART

Constant increase in greenhouse gases has now become a global issue as it leads to a diverse set of direct and indirect effects on all living beings. One of the most well-known effects of greenhouse gases is global warming where the rising level of atmospheric CO₂ is the main contributor. CO₂ is a major anthropogenic greenhouse gas, and according to the National Oceanic and Atmospheric Administration of the United States (NOAA), the average CO₂ concentration in the atmosphere was around 412.30 ppm by the beginning of 2020, which is 21.69% higher than that recorded in 1980 of 338.80 ppm. Therefore, scientists are devoted to finding solutions for reducing the levels of CO₂ in the atmosphere. Another major concern of CO₂ gas is that it is highly toxic and is prone to leakage in high quantities. This may result in indoor air becoming largely unbreathable.

Although the world is now moving towards using more renewable energy sources aiming to reduce CO₂ emission, in the long run, this approach will not be sufficient to reduce the CO₂ level in the air or in the atmosphere. Therefore, it is vital to find alternative methods that are capable of adsorbing CO₂ in air. Nano wires, nano fibres of metal oxides, organic and inorganic membranes are the current materials of interest by many in this field of research. The main challenge of these materials is the complexity and significantly high costs in mass production of such materials in the industrial sector at large.

The current CO₂ capture and separation techniques can be divided into three groups, namely pre-combustion capture, post-combustion capture and oxyfuel combustion which captures CO₂ from power plants and other industrial scale factories. Unlike liquid and membrane adsorbents, solid adsorbents are able to function at a wider temperature range and possess the ability to desorb the CO₂ without major hazards. Solid adsorbents used in industrial exhaust gases have proven to be effective in capturing concentrated CO₂ for subsequent storage instead of direct emission to the environment.

In recent years, solid adsorbents such as zeolites, carbon, metal organic frame works, alkali metal and amine adsorbents have been investigated for promising CO₂ capture properties. Generally, many metal oxides are considered to be promising candidates for adsorbing CO₂. However, their natural structural and morphological properties prevent them from achieving high adsorption capabilities that are useful on an industrial scale. Further, conventional adsorbents often require high temperatures to operate, which is highly energy consuming.

In view of the above, there is a need to provide a material and method for capturing CO₂ that at least partially ameliorates the disadvantages discussed above.

### SUMMARY

In an aspect, there is provided a material comprising an anion-doped alkaline earth metal oxide.

Advantageously, the material as defined above may be used to effectively and efficiently adsorb CO₂ from air at room temperature. In particular, the material may comprise an oxide of an alkaline earth metal such as magnesium that has been doped with an anion such as a halide, sulphate, or phosphate. Further advantageously, the doping may improve the CO₂ adsorption properties of the oxide of the alkaline earth metal, by preventing the formation of side-products such as carbonates on the surface of the material. This may significantly increase the CO₂ adsorption capacity of the material as defined above over time.

Advantageously, the material as defined above may have high porosity and high surface area, thereby having an increased number of carbon capture sites to improve CO₂ adsorption. This may facilitate adsorption of CO₂ at room temperature whereby the material may chemically bind with CO₂ to make it more stable. The material as defined above may exhibit higher CO₂ adsorption capacities at room temperature compared to conventional sorbents, and may be suitable for commercial use as a room temperature CO₂ sorbent.

Further advantageously, the material as defined above may store CO₂ within the material. Further advantageously, the adsorbed CO₂ may be desorbed, and this process of adsorbing and desorbing CO₂ may be repeated multiple times, facilitating the repeated use of the material over a longer period of time. Advantageously, the material may be stable over multiple adsorption-desorption cycles.

In another aspect, there is provided a method for preparing the material as defined above, comprising the step of contacting a hydroxide salt of an alkaline earth metal with a second salt of the alkaline earth metal.

Advantageously, the material as defined above may be prepared in a cost-efficient manner by the method as defined above. Due to its high cost-effectiveness, the method may advantageously be used in up-scaled or mass production of the material.

In an example, the method may comprise the step of forming the material as defined above into nanofibers, which may be performed by electrospinning. Previously known methods for synthesizing MgO sorbents were high-cost processes. Electrospinning, in contrast, may be more economical both in terms of time and costs. Electrospinning may also advantageously be more robust, durable, versatile, adaptable and scalable. Electrospinning may facilitate formation of structures in 1-dimension, 2-dimension as well as amorphous nanomaterials. Moreover, the resultant nanomaterials made by electrospinning may easily be functionalized by employing both chemical and physical surface treatments. Advantageously, electrospinning may facilitate up-scale or mass production of the material as defined above.

In another aspect, there is provided a material obtainable by the method as defined above.

In another aspect, there is provided a method for adsorbing CO₂ from an environment, the method comprising the step of contacting the material as defined above with the environment.

In another aspect, there is provided the use of the material as defined above to adsorb CO₂ from an environment.

Advantageously, the material as defined above may be used for CO₂ adsorption at room temperature, thereby avoiding the CO₂ adsorption process to be performed under highly energy consuming high-temperature conditions.

### Definitions

The following words and terms used herein shall have the meaning indicated:

The term “doped” for the purposes of this disclosure refers to the introduction of impurities such as anions into the lattice structure of the oxide of the alkaline earth metal or minerals thereof, so as to alter their phase stability and physical and chemical properties of the formed phases. The term “doping” should be construed accordingly.

The term “mineral” for the purposes of this disclosure refers to compounds comprising an oxide or hydroxide of an alkaline earth metal, water and a carbonate.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of

### DETAILED DISCLOSURE OF OPTIONAL EMBODIMENTS

There is provided a material comprising an anion-doped alkaline earth metal oxide.

The alkaline earth metal oxide may be an oxide of an alkaline earth metal. The oxide of the alkaline earth metal may be doped with an anion.

The material may be a sorbent suitable for adsorbing CO₂.

The alkaline earth metal may be selected from the group consisting of Mg, Ca, Sr, Ba and any mixture thereof.

Alkaline earth metals and their oxides may be readily and cheaply available as a by-product of sea water desalination, facilitating the cost-effective use of the material as defined above. Further, oxides of alkaline earth metals may facilitate the adsorption of CO₂ at room temperature by chemically binding with CO₂ to make it more stable.

The alkaline earth metal may be magnesium. The oxide of the alkaline earth metal may be MgO.

Magnesium (Mg) based minerals may advantageously be non-toxic and abundant, as they may be prepared in large scale with relatively low cost.

MgO or a mineral thereof, such as MgO—Mg(OH)₂—H₂O, may have a high theoretical CO₂ capture capacity of 1100 mg CO₂/g.

The anion may be selected from the group consisting of halide, sulfate, nitrate, phosphate and any mixture thereof.

The halide may be selected from the group consisting of fluoride, chloride, bromide, iodide or any mixture thereof.

Under dry and high temperature conditions, MgO may react with CO₂ to form MgCO₃ in dry, high-temperature environments, as shown below:

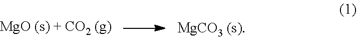

At lower temperatures, under moist conditions in the presence of H₂O, MgO may react with H₂O to form intermediate products or hydrates which may then in turn adsorb CO₂. H₂O molecules may further compete with CO₂ to occupy the adsorption sites on the surface of MgO. Furthermore, this reaction may occur on the surface of the MgO. That is, over time, the surface of MgO may be saturated with MgCO₃, causing a decrease in CO₂ capture sites and rendering it inactive.

Advantageously, by doping the oxide of the alkaline earth metal with an anion, the formation and accumulation of intermediate and side-products on the surface of the material may be prevented.

Generally, structure basic sites may favour reversible CO₂ adsorption, as represented in the following equation:

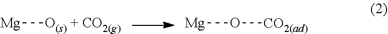

Advantageously, an increase in basic sites by incorporating the dopants, may result in better adsorption of CO₂ than without any dopants.

The material may comprise MgO doped with an anion selected from the group consisting of chloride, sulfate, phosphate and any mixture thereof.

The material may comprise the alkaline earth metal oxide, hydrates thereof, and/or a hydroxide salt of the alkaline earth metal.

The material my further comprise water. The water may be in the form of a hydrate. The material may comprise a hydrate of the alkaline earth metal oxide or a hydrate of the anion-doped alkaline earth metal oxide. Advantageously, due to a large number of hydrates present in the material, they may facilitate to anchor a large number of hydrogen bonds (H-bonds) from the water molecules on the surface of the material, which may eventually form bonds with CO₂ via chemisorption.

In the presence of water, by doping a MgO—H₂O binary system with Cl⁻, four main reaction phases may be formed in the resultant ternary MgO—MgCl₂—H₂O system.

The four phases may be:
1) Phase 2: 2Mg(OH)₂·MgCl₂·4H₂O,
2) Phase 3: 3Mg(OH)₂·MgCl₂·8H₂O,
3) Phase 5: 5Mg(OH)₂·MgCl₂·8H₂O, and
4) Phase 9: 9Mg(OH)₂·MgCl₂·5H₂O.

The water resistance and thermal stability of the four phases above, doped with Cl⁻, may be improved when reacting the material with CO₂ from air to form magnesium chlorocarbonates.

The four ternary compounds may have improved water resistance, thermal stability, and CO₂ capture compared to MgO or Mg(OH)₂ when reacted with CO₂ in air.

The anion-doped alkaline earth metal oxide as defined above may comprise the phase 2 ternary compound, 2Mg(OH)₂. MgCl₂.4H₂O. The doped MgO may comprise impurities which may contribute to CO₂ adsorption and mineralization, due to formation of magnesium chlorocarbonates.

The hydrate of the alkaline earth metal oxide or the hydrates of the anion-doped alkaline metal oxide may be selected from the group consisting of MgO—Mg(OH)₂—H₂O, MgO—MgCl₂—H₂O, 2Mg(OH)₂·MgCl₂·4H₂O, 3Mg(OH)₂·MgCl₂·8H₂O, 5Mg(OH)₂·MgCl₂·8H₂O, 9Mg(OH)₂·MgCl₂·5H₂O, Mg(ClO₄)₂·xH₂O wherein x may be 1 or 2, Mg₂Cl₂CO₃·7H₂O, C₈H₂₀Cl₂MgO₆, MgCl₂(H₂O)+, Mg₂CO₃(OH)₂·3H₂O, Mg₂CO₃(OH)₂·3H₂O, Mg₆O₅SO₄·8H₂O, C₃H₂MgO₄·2H₂O, Mg₃(PO₄)₂·22H₂O, Mg₅(CO₃)₄(OH)₂(H₂O)₄, and any mixture thereof.

When MgO reacts with H₂O to form Mg(OH)₂, lower CO₂ capture efficiency may be observed due to the replacement of CO₂-philic MgO by CO₂-phobic Mg(OH)₂. However, the CO₂-phobic Mg(OH)₂ may act to transport or repel CO₂ away from the MgO sites designed to adsorb CO₂, allowing more CO₂ to penetrate the MgO/Mg(OH), composite surface/interface and diffuse into the bulk of the material. The formed hydrates may therefore aid in increasing the CO₂ capture capacity of the material.

The material may be in the form of nanofibers, flakes, rods, sheets, powder or any mixture thereof.

The powder may be a fine powder. The fine powder may have a particle size in the range of about 0.5 μm to about 5 μm, about 0.5 μm to about 1 μm, about 0.5 μm to about 2 μm, about 1 μm to about 2 μm, about 1 μm to about 5 μm or about 3 μm to about 5 μm.

The nanofiber may be ground to form the fine powder.

The fine powder may comprise sheet-like structures or rod-like structures.

There is also provided a method for preparing the material as defined above, comprising the step of contacting a hydroxide salt of an alkaline earth metal with a second salt of the alkaline earth metal.

The second salt of the alkaline earth metal may not be the same as the hydroxide salt of the alkaline earth metal.

The hydroxide salt of the alkaline earth metal may be Mg(OH)₂.

The hydroxide salt of the alkaline earth metal may be a precursor of the oxide of the alkaline earth metal. The contacting of the hydroxide salt of the alkaline earth metal with the second salt of the alkaline earth metal may result in the formation of the anion-doped oxide of the alkaline earth metal.

The second salt of the alkaline earth metal may be selected from the group consisting of an alkaline earth metal halide, an alkaline earth metal sulfate, an alkaline earth metal nitrate, an alkaline earth metal phosphate and any mixture thereof. The second salt of the alkaline earth metal may be selected from the group consisting of MgCl₂, MgSO₄, Mg₃PO₄ and any mixture thereof.

The ratio between the hydroxide salt of the alkaline earth metal and the second salt of the alkaline earth metal may be in the range of about 99.9:0.1 to about 80:20 by weight, about 99.9:0.1 to about 99.5:0.5, about 99.9:0.1 to about 99:1, about 99.9:0.1 to about 98:2, about 99.9:0.1 to about 95:5, about 99.9:0.1 to about 90:10, about 99.5:0.5 to about 99:1, about 99.5:0.5 to about 98:2, about 99.5:0.1 to about 95:5, about 99.5:0.5 to about 90:10, about 99.5:0.5 to about 80:20, about 99:1 to about 98:2, about 99:1 to about 95:5, about 99:1 to about 90:10, about 99:1 to about 80:20, about 95:1 to about 90:10, about 95:1 to about 80:20 or about 95:10 to about 80:20 by weight.

The contacting step may be performed in a solvent.

The solvent may comprise acetic acid, water, or a mixture thereof.

The water may be deionized water.

The solvent may comprise glacial acetic acid or a mixture of acetic acid and water. The acetic acid may be present in a concentration in the range of about 0.2 M to about 17.5 M, about 0.2 M to about 0.5 M, about 0.2 M to about 1 M, about 0.2 M to about 2 M, about 0.2 M to about 5 M, about 0.2 M to about 10 M, about 0.2 M to about 15 M, about 0.5 M to about 1 M, about 0.5 M to about 2 M, about 0.5 M to about 5 M, about 0.5 M to about 10 M, about 0.5 M to about 15 M, about 0.5 M to about 17.5 M, about 1 M to about 2 M, about 1 M to about 5 M, about 1 M to about 10 M, about 1 M to about 15 M, about 1 M to about 17.5 M, about 2 M to about 5 M, about 2 M to about 10 M, about 2 M to about 15 M, about 2 M to about 17.5 M, about 5 M to about 10 M, about 5 M to about 15 M, about 5 M to about 17.5 M, about 10 M to about 15 M, about 10 M to about 17.5 M or about 15 M to about 17.5 M.

The choice of solvent may determine the property of the material, for example the morphology, chemical structure, spinnability and viscosity of the material. If MgO, Mg(OH)₂ or any other magnesium related anions are used as the alkaline earth metal oxide or alkaline earth metal hydroxide, then acetic acid may be the most suitable solvent for dissolving the oxide or hydroxide.

The contacting step may further comprise a polymer.

The polymer may be polyvinyl acetate or polyacrylonitrile.

The polymer may be present in the form of an aqueous solution.

The ratio between the hydroxide salt of the alkaline earth metal and the polymer may be in the range of about 1:5 to about 1:20, about 1:5 to about 1:5 to about 1:7, about 1:5 to about 1:10, about 1:5 to about 1:12, about 1:5 to about 1:15, about 1:7 to about 1:10, about 1:7 to about 1:10, about 1:7 to about 1:12, about 1:7 to about 1:15, about 1:7 to about 1:20, about 1:10 to about 1:12, about 1:10 to about 1:15, about 1:10 to about 1:20, about 1:12 to about 1:15, about 1:12 to about 1:20 or about 1:15 to about 1:20 by weight.

The hydroxide salt of the alkaline earth metal and the second salt of the alkaline earth metal in the solvent may be contacted with the aqueous solution of the polymer.

The contacting step may comprise the step of mixing.

The method may further comprise the step of forming the material into fibres.

The forming step may be performed by electrospinning. The electrospinning may be performed using the mixture of the hydroxide salt of the alkaline earth metal, the second salt of the alkaline earth metal and the polymer, in the solvent.

The presence of the polymer may facilitate the electrospinning step. The polymer may act as a medium for the hydroxide salt of the alkaline earth metal and the second salt of the alkaline earth metal to be electrospun.

The polymer may not participate in any chemical reactions, and may only be present to facilitate the electrospinning process. The polymer may be used to tailor the fluid viscosity and dielectrics of the material during the electrospinning step. If acetic acid is present in the solvent, polyvinyl acetate, which contains acetate groups, may be a suitable polymer.

The method may further comprise the step of removing the solvent.

The solvent may be removed by drying. The drying may be performed at a temperature in the range of about 50° C. to about 70° C., about 50° C. to about 60° C., or about 60° C. to about 70° C., for a duration in the range of about 24 hours to about 72 hours, 24 hours to about 36 hours, 24 hours to about 48 hours, about 36 hours to about 48 hours, about 36 hours to about 72 hours, or about 48 hours to about 72 hours.

The method may further comprise the step of calcining the material. The calcining step may be performed after removal of the solvent.

The calcining step may be performed at a temperature in the range of about 250° C. to about 350° C., about 250° C. to about 300° C. or about 300° C. to about 350° C., for a duration in the range of about 1 hour to about 3 hours, about 1 hour to about 2 hours or about 2 hours to about 3 hours.

The calcining step may remove any organic matter from the material. The calcining step may remove the polymer from the material. Further, the calcining step may convert the hydroxide of the hydroxide salt of the alkaline earth metal to the oxide of the alkaline earth metal. After the calcining step, the material may comprise the alkaline earth metal oxide, hydrates thereof, and/or residual hydroxide salt of the alkaline earth metal.

The method may further comprise the step of grinding the material into a powder. The material may be the calcined material. The powder may be a fine powder.

The method may further comprise the step of aging the material. The aging may be performed by exposing the material in the form of a powder to ambient air at room temperature for a duration of time.

The temperature during the aging step may be in the range of about 20° C. to about 35° C., about 20° C. to about 25° C., about 20° C. to about 30° C., about 25° C. to about 30° C., about 25° C. to about 35° C. or about 30° C. to about 35° C.

Ambient air may be atmospheric air in its natural state. Atmospheric air may comprise nitrogen, oxygen and traces of other gases such as argon, helium, carbon dioxide and ozone. Atmospheric air may comprise about 78% nitrogen and about 21% oxygen.

The relative humidity of the atmospheric air may be in the range about 40% to about 70%, about 40% to about 50%, about 40% to about 60%, about 50% to about 60%, about 50% to about 70% or about 60% to about 70%. Relative humidity may refer to the ratio of the amount of moisture in the air at the temperature as defined above, to the maximum amount of moisture that the air may retain at the same temperature.

The duration of the aging step may be in the range of about 2 months to about 12 months, about 2 months to about 4 months, about 2 months to about 6 months, about 4 months to about 6 months, about 4 months to about 12 months or about 6 months to about 12 months.

The pressure during the aging step may be atmospheric pressure of about 101,325 Pa, 1,013.25 hPa or 1,013.25 mbar.

There is also provided a material obtainable by the method as defined above.

There is also provided a method for adsorbing CO₂ from an environment, the method comprising the step of contacting the material as defined above with the environment.

The environment may be gas or liquid.

The gaseous environment may be the atmosphere.

The atmosphere may comprise air.

The liquid environment may be an aqueous solution. The aqueous solution may be sea water or wastewater. The material as defined above may adsorb CO₂ dissolved in the liquid and may be useful in reversing acidification of the liquid.

There is also provided the use of the material as defined above to adsorb CO₂ from an environment.

The CO₂ adsorption using the material as defined above may be performed at room temperature, or at a temperature in the range about 20° C. to about 35° C., about 20° C. to about 25° C., about 20° C. to about 30° C., about 25° C. to about 30° C., about 25° C. to about 35° C. or about 30° C. to about 35° C.

The adsorbed CO₂ may be stored in the material as defined above. The adsorbed CO₂ may be stored in the material for a duration in the range of about 1 second to about 12 months, about 1 second to about 1 day, about 1 second to about 1 week, about 1 second to about 1 month, about 1 day to about 1 week, about 1 day to about 1 month, about 1 day to about 12 months, about 1 week to about 1 month, about 1 week to about 12 months or about 1 month to about 12 months. The adsorbed CO₂ may be stored in the material for a duration in the range of about 1 week to about 3 months or about 1 week to about 6 months.

The adsorbed CO₂ may be desorbed from the material as defined above.

CO₂ may be desorbed from the material as defined above via the decomposition of the formed magnesium carbonate minerals, when the CO₂ level falls below the equilibrium CO₂ partial pressure, which is the reverse reaction of mineral formation.

There is also provided a method for storing CO₂, the method comprising the steps of:
i) adsorbing CO₂ from an environment by contacting the material as defined above with the environment;
ii) storing the CO₂ in the material as defined above; and
iii) desorbing the CO₂ from the material as defined above.

The steps (i) to (iii) may be repeated multiple times.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 refers to graphs showing the comparison of CO₂ adsorption in 1%, 5% and 10% doped samples of FIG. 1a: Cl⁻ doped MgO samples, FIG. 1b: SO₄²⁻ doped MgO samples, and FIG. 1c: PO₄³⁻ doped MgO samples.

FIG. 2 refers to graphs showing the CO₂ uptake capacity after 6 months of aging of FIG. 2a(i): 1% Cl⁻ doped MgO, FIG. 2a(ii): 5% Cl⁻ doped MgO and FIG. 2a(iii): 10% Cl⁻ doped MgO, FIG. 2b(i): 1% SO₄²⁻ doped MgO, FIG. 2b(ii): 5% SO₄²⁻ doped MgO and FIG. 2b(iii) 10% SO₄²⁻ doped MgO and FIG. 2c(i) 1% PO₄³⁻ doped MgO, FIG. 2c(ii) 5% PO₄³⁻ doped MgO and FIG. 2c(iii) 10% PO₄³⁻ doped MgO.

FIG. 3 refers to graphs showing the comparison of FIG. 3a: XRD data of 1%, 5% and 10% Cl⁻ doped MgO electrospun sorbent samples; FIG. 3b: magnification of the broader peaks 2θ=10°-35° associated with hydrates in the samples with increasing Cl percentage; FIG. 3c: XRD analysis data of 1%, 5% and 10% SO₄²⁻ doped MgO electrospun sorbent samples; FIG. 3d: magnification of peaks 2θ=10°-35° associated with hydrates related to SO₄²⁻ in the samples with increasing SO₄²⁻ percentage: FIG. 3e: XRD analysis data of 1%, 5% and 10% PO₄³⁻ doped MgO electrospun samples; FIG. 3f: Magnification of peaks 2θ=10°-35° associated with hydrates related to PO₄³⁻ in the samples with increasing PO₄³⁻ percentage. The sorbent samples were calcinated at 300° C., having a peak shift of (2 0 0), (1 1 1) and (1 1 1), (2 0 0) peak broadening and shifting.

FIG. 4 refers to SEM images of sorbent samples after calcination at 300° C. FIG. 4A: Cl⁻ doped sorbent sample, FIG. 4B: SO₄²⁻ doped sorbent sample and FIG. 4C: PO₄³⁻ doped sorbent sample, where a, b and c refer to 1%, 5% and 10% dopants in each sample. Scale bar represents 1 μm.

FIG. 5 refers to: FIG. 5a: comparison of CO₂ adsorption of the 10% Cl⁻ doped MgO samples calcined at 300° C., 500° C. and 700° C., FIG. 5b: comparison of XRD analysis of the structures of 10% Cl⁻ doped MgO samples calcinated at 300° C., 500° C. and 700° C. for 2 hours, FIG. 5c: SEM image of the 10% Cl⁻ doped MgO sample calcinated at 500° C., and FIG. 5d: SEM image of the 10% Cl⁻ doped MgO sample calcinated at 700° C. at high magnification. Scale bar represents 10 μm.

FIG. 6 refers to graphs showing BET analysis adsorption-desorption curves of the FIG. 6a: 1% Cl⁻ doped MgO sample, FIG. 6b: 5% Cl⁻ doped MgO sample and FIG. 6c: 10% Cl⁻ doped MgO sample.

FIG. 7 refers to graphs showing the CO₂ gas sensing analysis for the 5% Cl⁻ doped MgO sample that was found to have a high BET surface area

FIG. 8 refers to CO₂ adsorption/desorption curves of 10% Cl⁻ doped sorbent sample over 10 cycles at 30° C. (Adsorption condition: 30° C., 1 atm, 100% pure CO₂, 1.5 hours. Desorption condition: 30° C., 1 atm, 100% pure N₂, 1 hour).

### EXAMPLES

Non-limiting examples of the invention will be further described in greater detail by reference to specific Examples, which should not be construed as in any way limiting the scope of the invention.

### Materials and Methods

For sample synthesis, analytical grade polyvinyl acetate (PVA) (MW 89,000-98,000, 99+% hydrolyzed) and as the precursor, reagent grade Mg(OH)₂ 95% were purchased from Sigma-Aldrich (St. Louis, Missouri, USA). Analytical grade glacial acetic acid (AA) 99.8% was purchased from Scharlab (Barcelona, Spain). Magnesium chloride (MgCl₂), magnesium phosphate 98+% (Mg₃(PO₄)₂) and magnesium sulphate (MgSO₄) analytical grade were purchased from Sigma-Aldrich (St. Louis, Missouri, USA), Acros Organics (The Hague, Netherlands) and Shanghai Macklin Biochemicals Co. Ltd (Shanghai, China), respectively. All the chemicals were used without further purification. The water utilized in the experiments was deionized water (18 MΩ·cm).

### Instrumentation and Characterization

X-ray diffraction (XRD) measurements were conducted on a Bruker D8 Advance X-ray diffractometer (Bruker Corporation, Billerica, Massachusetts, USA) with Cu—Kα radiation of 1.54 Å to evaluate powder's composition and phase. The scanning angle was adjusted between 2θ angles 10° to 140° with the X-ray generator running at applied voltage 40 kV and current 25 mA. CO₂ capture behaviour was examined using a Thermogravimetric analyser (TGA) TGA Q50 analyser (TA Instruments, New Castle, Delaware, USA). Surface structure and morphology were examined by scanning electron microscopy (SEM) JEOL JSM-7600F (JEOL Ltd, Tokyo, Japan). The porosity of the samples was studied by Brunauer-Emmett-Teller (BET) ASAP 2020 Specific Surface Analyzer (Micrometrics Instrument Corporation, Norcross, Georgia USA). Brunauer-Emmett-Teller (BET) test condition was in low pressure and 200° C. using 0.5 g of powder samples. To study the CO₂ gas sensing properties the prepared sensor was electrically connected to a Keithley 2400 Source meter (Keithley Instruments, Cleveland, Ohio, USA) and measured the properties.

### Evaluation of CO₂ Adsorption Capacity

CO₂ capture capacity was examined by performing a CO₂ adsorption experiment, using a Q50 (TA instruments, New Castle, Delaware, USA), by loading 5 to 8 mg of the sorbent (anion-doped MgO—Mg(OH)₂—H₂O—CO₂ quaternary system) to a platinum (Pt) pan in the TGA unit. To avoid errors caused by impurities such as pre-adsorbed species, atmospheric CO₂, water, and other impurities, samples were subjected to pre-calcination at 150° C. for 60 minutes under a flow of high purity N₂ (40 mL min⁻¹) with a ramp rate of 10° C. min⁻¹. The temperature was then lowered to the desired adsorption temperature at a rate of 10° C. min⁻¹, the gas was switched from N₂ to CO₂ with a constant flow of high purity CO₂ (1 atm, 40 mL min⁻¹), and the CO₂ adsorption uptake was measured for 1.5 hours. The CO₂ levels in TGA measurements approached a near plateau when the testing duration reached 1.5 hours, and adsorption was at the maximum CO₂ capture capacity.

### Sample Preparation for Gas Sensing

Alpha-terpineol was purchased from Sigma-Aldrich (St. Louis, Missouri, USA) as the binder and 0.01 g of Mg(OH)₂ powder was mixed 0.01 mL of alpha-terpineol. Then, this mixture was coated on the electrode of the source meter using screen printing. Subsequently, the samples were dried at 60° C. for 30 minutes. Finally, to remove the remaining solvents, the samples were heat-treated at 250° C. for 1 hour.

### Gas Sensing Test

To study the CO₂ gas sensing properties of the sorbent, interdigitated Titanium (Ti) and Platinum (Pt) electrodes were deposited by direct current (DC) sputtering on the surfaces with thicknesses of 50 nm and 200 nm, respectively. The prepared sensor was electrically connected to a Keithley 2400 Source meter for the gas sensing measurements. Gas sensing characteristics were investigated using a horizontal-quartz heating chamber at a total flow of 500 sccm. Dynamic sensing data were recorded under a constant DC bias of 1 V. Output resistances were obtained in the presence of target gas (Rg) and air (Ra), and the sensor's response was defined as Ra/Rg. The CO₂ sensing properties of the sorbent was studied by testing in 50-5000 ppm CO₂ gas at different temperatures between 25° C.-300° C.

### Example 1: Synthesis of the Sorbents

### Preparation of PVA Solution

Aqueous polyvinyl acetate (PVA) (5% w/w) solution was first prepared by dissolving PVA powder in deionized water, at 90° C. for 2 hours. The solution was then cooled to room temperature (RT) and stirred continuously for another 12 hours.

Preparation 1 (PVA/Mg(OH)₂/MgCl₂ solutions (1% MgCl₂, 5% MgCl₂, 10% MgCl₂))

1% Cl⁻ solution was prepared by dissolving 0.0025 g MgCl₂ and 0.2475 g Mg(OH)₂ in 5 mL acetic acid via sonication in a water bath at 40° C. for 1 hour. Then, the solution was mixed with the 5% PVA as prepared above at a volume ratio of 15:100 (0.750 mL to 5 mL), with further sonication in a water bath at 40° C. for 20 minutes to eliminate precipitation. The 5% Cl⁻ solution was prepared by using 0.0125 g MgCl₂ and 0.2375 g Mg(OH)₂, and the 10% Cl⁻ solution was prepared by using 0.025 g MgCl₂ and 0.225 g Mg(OH)₂, followed by a similar procedure for the 1% Cl⁻ sample described above.

Preparation 2 (PVA/Mg(OH)₂/MgSO₄ Solutions (1% MgSO₄, 5% MgSO₄, 10% MgSO₄))

1% SO₄²⁻ solution was prepared by using similar weights as mentioned for Preparation 1, but MgSO₄ was used instead of MgCl₂. The measured samples were dissolved in 4 mL acetic acid and 2 mL deionized water via sonication in a water bath at 30° C. for 1 hour to prepare. The solution was then mixed with 5% PVA as prepared above at a 15:100 ratio (0.750 mL to 5 mL), with the aid of sonication in a water bath at 30° C. for 20 minutes to eliminate precipitation. Similarly, the 5% SO₄²⁻ solution was prepared by using 0.0125 g MgSO₄ and 0.2375 g Mg(OH)₂, and the 10% SO₄²⁻ solution was prepared by using 0.025 g MgSO₄ and 0.225 g Mg(OH)₂ followed by a similar procedure as for the 1% SO₄²⁻ sample described above.

Preparation 3 (PVA/Mg(OH)₂/Mg₃(PO₄)₂ Solutions (1% Mg₃(PO₄)₂, 5% Mg₃(PO₄)₂, 10% Mg₃(PO₄)₂))

1% PO₄³⁻ solution was prepared by measuring the similar weights mentioned in preparation, but Mg₃(PO₄)₂ was used instead of MgCl₂. The measured weights were dissolved in 7 mL of 5 moldm⁻³ acetic acid via sonication in a water bath at 30° C. for 1 hour. Then the aqueous solution was added to 5% PVA with a ratio of 3:28 (0.750 mL to 7 mL), with further sonication in a water bath at 30° C. for 20 minutes to eliminate precipitation. The 5% PO₄³⁻ solution was prepared by using 0.0125 g Mg₃(PO₄)₂ and 0.2375 g Mg(OH)₂. The 10% PO₄³⁻ solution was prepared by using 0.025 g Mg₃(PO₄)₂ and 0.225 g Mg(OH)₂ followed by a similar procedure as for the 1% PO₄³⁻ sample described above.

Synthesis of Cl⁻, SO₄²⁻ and PO₄³⁻ Doped MgO Sorbent Samples

Electrospinning was carried out by using a needle-collector setup in top-down configuration with aluminum foil spread across the collector plate. All the samples were electrospun with an applied voltage of 20.5 kV and 21 G×½″ needle with the sharp end ground flat. The needle-collector distance was 12 cm, with a flowrate of 0.3 mL/hour. After electrospinning, the wet nanofiber layer deposited on the aluminum foil was oven-dried at 60° C. for 48 hours. This gave the solidified layer having a brittle consistency, which was then collected as flakes for calcination in a box furnace (Anhui Haibei 1100 model). During calcination, the furnace temperature was increased from 30 to 300° C. with a heating rate of 2° C./minute. The samples were heated at 300° C. for 2 hours, followed by air cooling to room temperature. The prepared doped MgO sorbent samples were then subjected to mechanical grinding using a mortar and pestle to obtain a fine powder.

### Aging

The aging treatment was carried out by exposing the fine powder samples of Cl⁻, SO₄²⁻ and PO₄³⁻ doped MgO sorbent samples as prepared above to ambient air conditions for 3 months to 6 months.

### Example 2: Sorbent Design Rationale

Current research in CO₂ sorbents adopt a trial-and-error approach, which is an approach that is not only time consuming but may also risk overlooking optimal doping chemicals. Bioinspired water harvesting materials have been known to take inspiration from a mechanism used by Namib Desert Beetles whose surface structures and chemistries enable them to collect water from fog by firstly facilitating nucleation and growth of water vapor molecules into droplets on wax-free hydrophilic bumps and then transporting the droplets towards the mouth of the beetle by the waxy hydrophobic surroundings. An important point to note is to separate the water harvesting action into two processes: (1) water droplet formation at hydrophilic sites, and (2) water droplet transportation along hydrophobic channels. This concept may be adapted in the present technology, to fill the gap between the current trial-and-error approach and bioinspired rational design strategies, in the development of MgO-based CO₂ adsorbents.

To design a highly efficient CO₂ adsorbent, it was necessary to develop a tool that may couple the surface CO₂-philic and CO₂-phobic properties to balance the nucleation and transportation process during CO₂ absorption so that the surface of the adsorbent will not be completely blocked by the formed MgCO₃, and therefore more CO₂ molecules may be further adsorbed. Therefore, a chemical doping method was explored based on the so-called iso-diagonality in the Periodic Table of Elements. The iso-diagonal trend refers to a pair of elements (such as carbon/phosphorus and nitrogen/sulphur pairs) that have an adjacent upper left/lower right relative location in the Periodic Table of Elements, which are believed to have similar size and electronegativity, resulting in similar trends in properties. It is less explored than the vertical and horizontal trends. For instance, it is well accepted that nitrites (NO₂⁻) promote CO₂ adsorption in MgO based sorbents, since carbon and nitrogen are located close by in the same period of the Periodic Table of Elements. Accordingly, new dopants that may have similar properties as either carbon/oxygen (the two constituent elements of CO₂) or nitrogen were explored, using the iso-diagonal relationship of carbon, nitrogen, and oxygen. Their respective iso-diagonal partner, phosphorous (P), sulphur (S), and chlorine (Cl), were therefore tested as new dopants to nano MgO—Mg(OH)₂ composites in order to balance the surface CO₂-philic and CO₂-phobic properties for efficient CO₂ absorption.

### Example 3: CO₂ Adsorption of Doped MgO Sorbent (As Prepared)

Each precursor solution was prepared by incorporating MgCl₂, MgSO₄ or Mg₃(PO₄)₂ with Mg(OH)₂ and adding different amounts of acetic acid and water as solvents. First, the sorbents were tested for its CO₂ adsorption capacities using thermo gravimetric analysis (TGA). All sorbents developed had over 2 w % of CO₂ adsorption capacity.

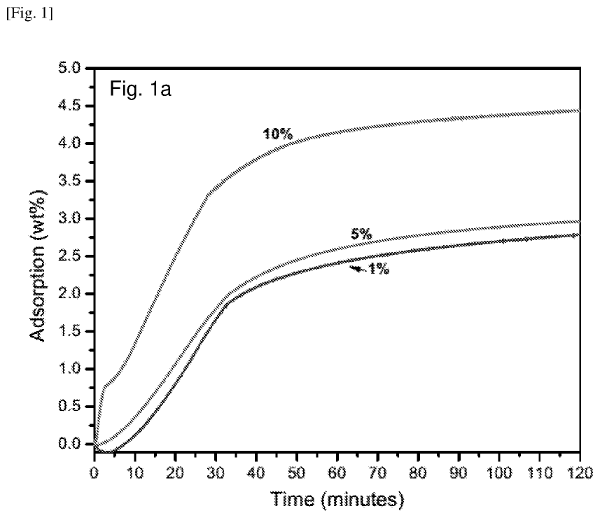

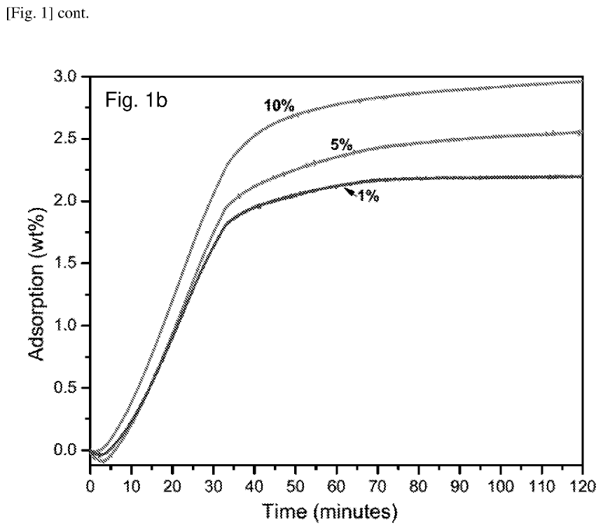

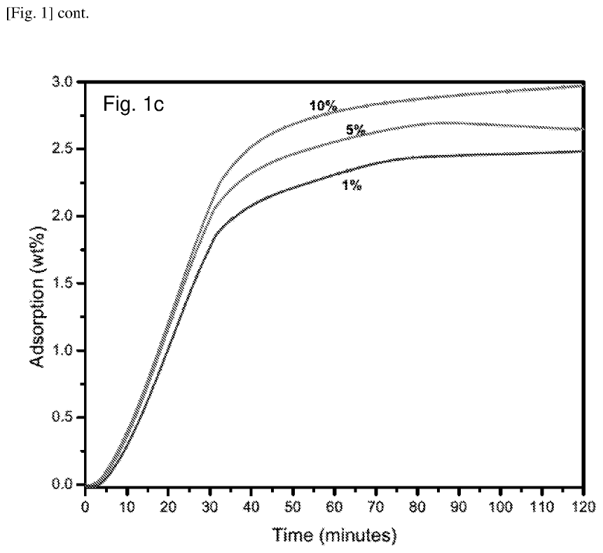

The Cl⁻ doped samples calcinated at 300° C. recorded the highest capture capacity compared to the SO₄²⁻ and PO₄³⁻ doped samples calcinated at 300° C. Maximum adsorption capacity at 1.5 hours was shown by the 10% Cl⁻ doped sample indicating an adsorption of 5.59 wt %, while 5% Cl⁻ and 1% Cl⁻ doped sorbent samples indicated an adsorption of 2.79 wt % and 2.97 wt %, respectively, at 1.5 hours, as shown in FIG. 1a. This indicated that an enhanced surface area of the materials may promote CO₂ capture.

However, the SO₄²⁻ and PO₄³⁻ doped sorbent samples recorded low adsorption capacities as shown in FIG. 1b and FIG. 1c, respectively. MgO doped with SO₄²⁻ recorded its maximum adsorption for the 10% SO₄²⁻ doped sorbent sample and adsorption capacity decreased with decreasing amounts of dopants, as shown in FIG. 1b. The PO₄³⁻ doped sorbent samples also followed a similar trend as shown in FIG. 1c. Adsorption capacities of sorbent samples doped with SO₄²⁻ and PO₄³⁻ were shown to be lower in comparison with the Cl⁻ doped sorbent samples. However, it was evident that with increasing dopant percentage, CO₂ adsorption capacity also increased. Even though the Cl⁻ doped sorbent samples recorded the highest adsorption capacity using TGA, the 10% Cl⁻ doped sorbent sample underperformed during gas sensing testing. This is further discussed in Example 9.

### Example 4: CO₂ Adsorption of Doped MgO (Aged)

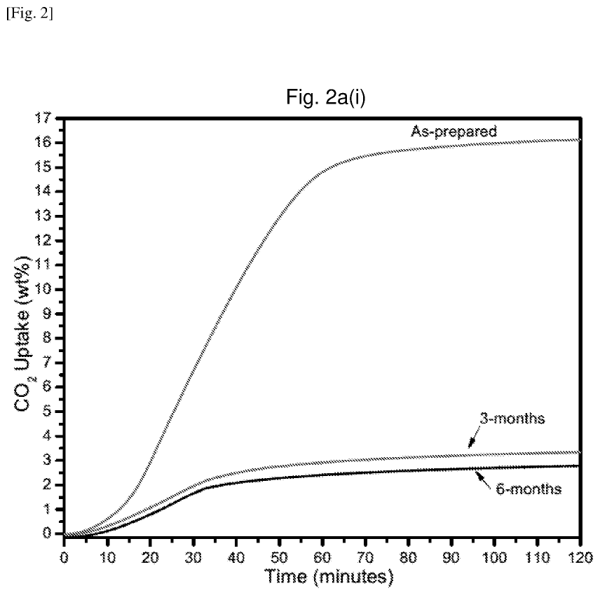

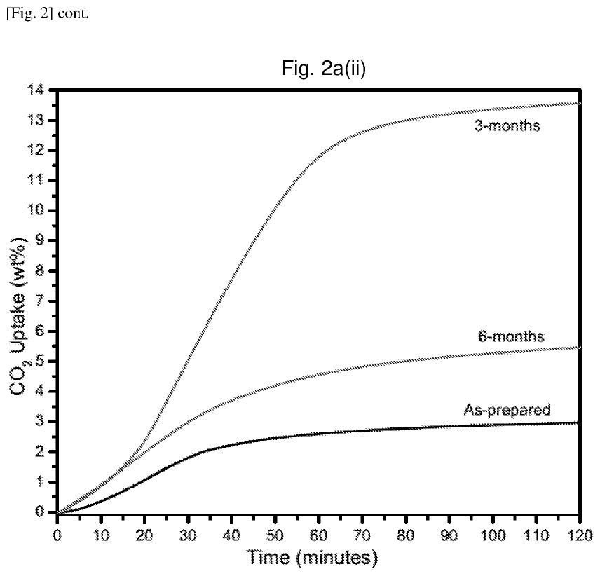

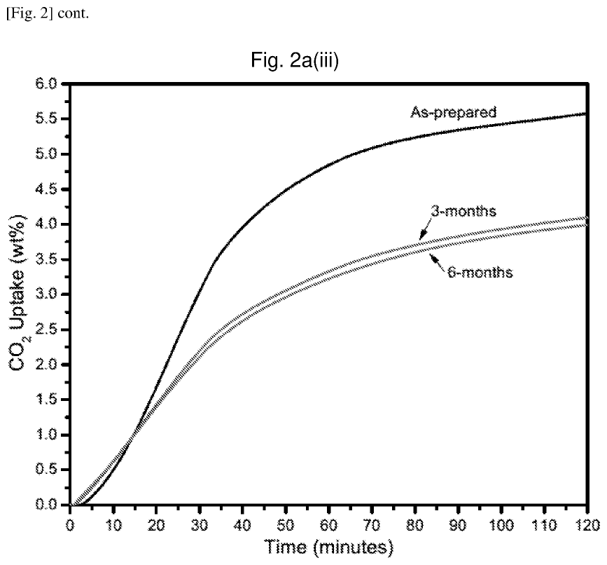

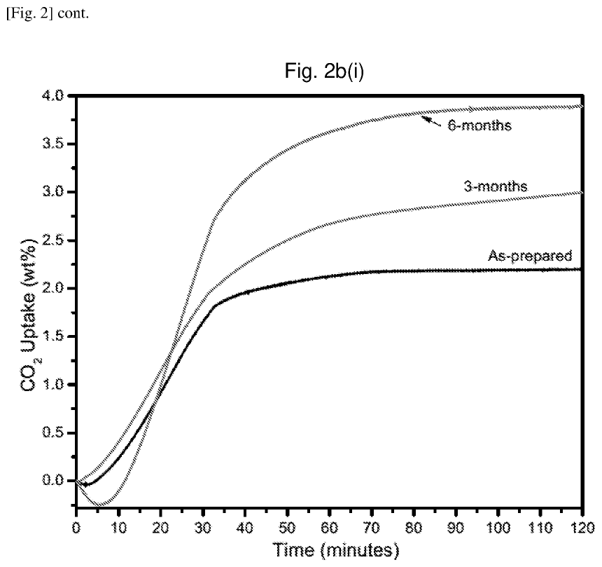

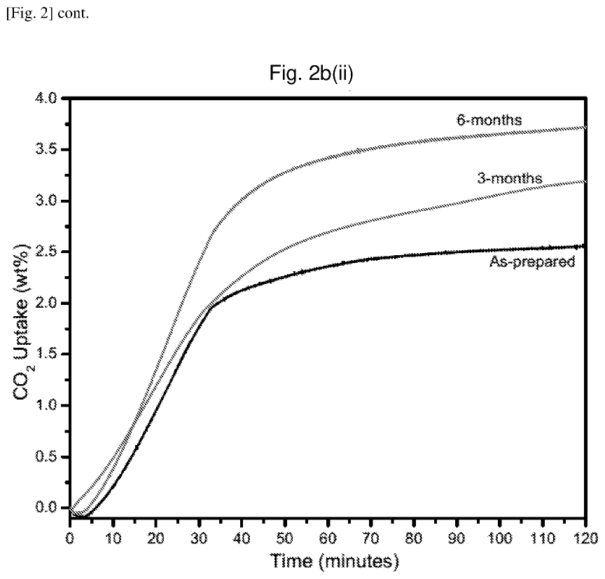

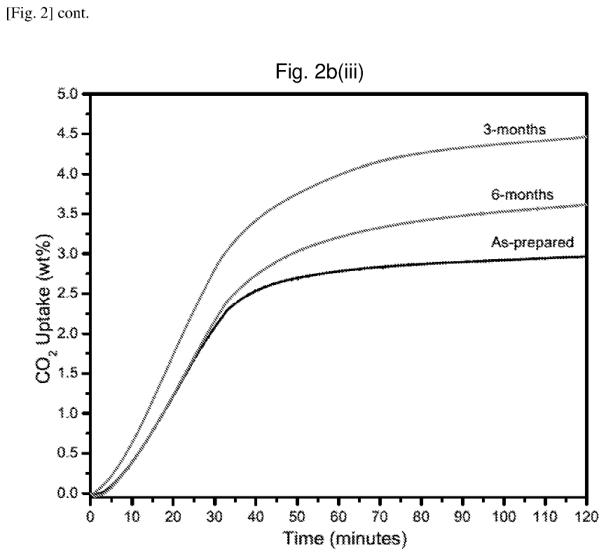

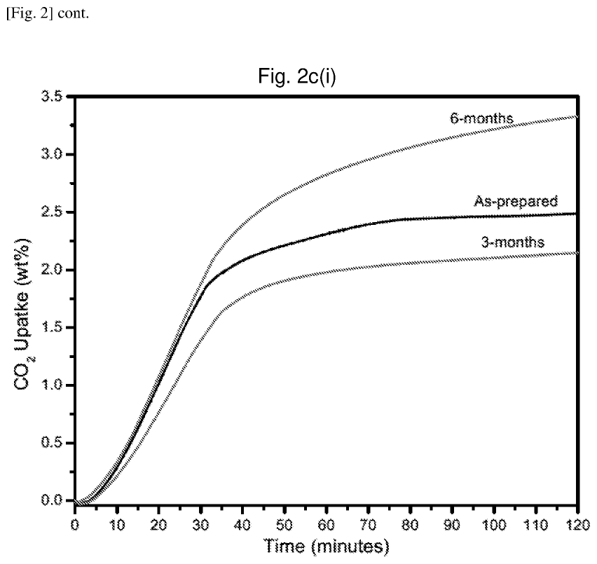

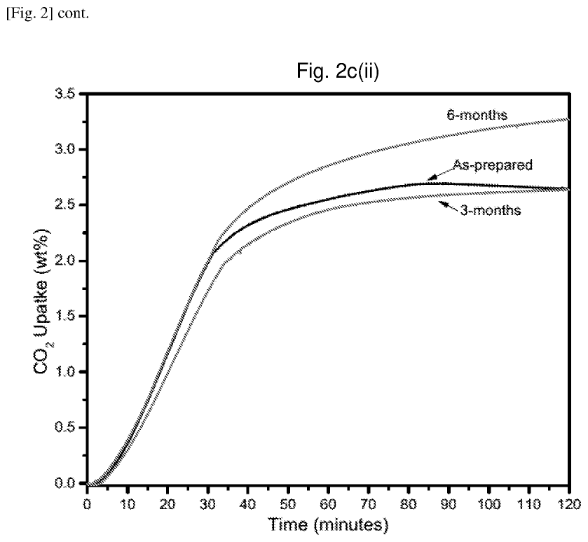

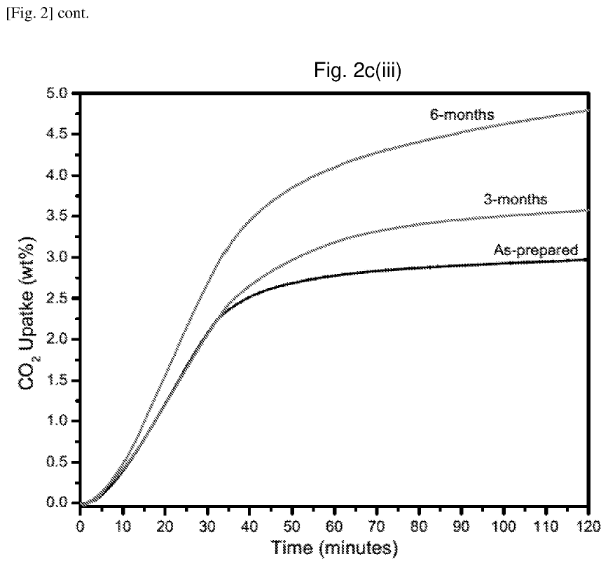

To determine the CO₂ adsorption capacities of the aged Cl⁻ doped MgO samples, TGA analysis was carried out for 2 hours on the sorbent samples. The electrospun Cl⁻ doped MgO samples were aged over 6 months and the CO₂ adsorption capacity was evaluated via a thermogravimetric method at 30° C. (FIG. 2). The CO₂ adsorption capacity was evaluated on the same sorbent sample: 1) as prepared, 2) 3-month aged and 3) 6-month aged, to evaluate the effects of long-term sorbent performance.

The MgO sorbent samples doped with Cl⁻ reported higher CO₂ adsorption capacities before and after aging. The 1% Cl⁻ doped sorbent sample exhibited increased absorption with increase in aging time for up to 6-months. The 1% Cl⁻ doped sorbent sample recorded a higher adsorption capacity of 16.15% at 6 months of aging, which was a large increase from its initial value of 2.79 wt % measured before aging treatment, as shown in FIG. 2a and Table 1, even though the 1% Cl⁻ doped sorbent sample did not have a significantly higher Brunauer-Emmett-Teller (BET) surface area (discussed in Example 8). Nevertheless, the 1% Cl⁻ doped sorbent sample achieved the best adsorption capacity after 6 months of aging, which indicated that CO₂ adsorption was not solely governed by surface area. Furthermore, interestingly, after 3 months of aging, the 5% Cl⁻ doped sorbent sample was shown to have a high CO₂ adsorption of 13.95 wt % within 2 hours, yet after 6 months of aging, the same 5% Cl⁻ doped sorbent sample showed a decrease in adsorption capacity, having an adsorption of 5.48 wt % within 2 hours. MgO doped with 10% Cl⁻ showed a slight decrease in CO₂ adsorption, from its adsorption capacity as prepared of 5.59 wt % to 4.11 wt % and 4.00 wt % after 3 months and 6 months of aging, respectively, indicating a decrease in adsorption with aging of the sorbent sample.

The behavior of the 1% Cl⁻ doped sorbent sample may be explained by the formation of C8 compounds such as nano-C₈H₁₀MgO₁₀·4H₂O. The 1% Cl⁻ doped sorbent sample, having less Cl⁻, may not have hindered the formation of the C8 compound, unlike the 5% and 10% Cl⁻ doped samples.

MgO doped with SO₄²⁻ showed a slight increase in CO₂ adsorption for the 1%, 5% and 10% doped sorbent samples, which showed 2.99 wt %, 3.19 wt % and 4.46 wt % CO₂ adsorption, respectively, at their 3-month aging time point. However, it was noted that this trend was not observed for the PO₄³⁻ doped sorbent samples, as the adsorption capacity of the 1% PO₄³⁻ doped sorbent samples decreased slightly after 3-months of aging from 2.48 wt % to 2.15 wt % and the CO₂ adsorption capacity of 5% PO₄³⁻ doped samples did not change with aging, remaining at 2.64 wt %.

In contrast, for the 10% PO₄³⁻ doped sorbent sample, an increase in absorption capacity from 2.98 wt % to 3.58 wt % was observed after 3 months of aging. However, unlike sorbent samples doped with Cl⁻ or SO₄²⁻, PO₄³⁻ doped sorbent samples showed an increase in adsorption capacities after 6 months of aging, of 4.80 wt %, 3.28 wt % and 3.33 wt % for 10%, 5% and 1% PO₄³⁻ doped sorbent samples, respectively. A summary of the CO₂ capture capacities of the sorbent samples is summarized in Table 1.

TABLE 1
Summary of CO₂ adsorption at 30° C. for 120 minutes for
Cl⁻ , PO₄³^{^{−}}and SO₄²^{^{−}} doped MgO samples

| | | Adsorption | Adsorption | Adsorption (wt %) |
|---|---|---|---|---|
| | | (wt %) 30° C. | (wt %) 30° C. | 30° C. |
| MgO Samples | Dopant % | As Prepared | Aged - 3 Months | Aged - 6 Months |
| Cl⁻ doped | 1 | 2.79 | 3.34 | 16.15 |
| | 5 | 2.97 | 13.95 | 5.48 |
| | 10 | 5.59 | 4.11 | 4.00 |
| SO₄²⁻ doped | 1 | 2.19 | 2.99 | 3.89 |
| | 5 | 2.55 | 3.19 | 3.72 |
| | 10 | 2.97 | 4.46 | 3.62 |
| PO₄³⁻ doped | 1 | 2.48 | 2.15 | 3.33 |
| | 5 | 2.64 | 2.64 | 3.28 |
| | 10 | 2.98 | 3.58 | 4.80 |

It is evident that the sorbent samples comprise excessive amounts of hydrates and carbonates, as shown by the XRD data as further discussed in Example 5. Extensive carbonation of sorbents may be a result of using them at room temperature conditions. The sorbents adsorb CO₂ from the atmosphere in typical indoor spaces where the temperature is approximately 25° C. and CO₂ levels are approximately 2200 ppm. The existence of H₂O enhances the carbonation process of the sorbents and this promotes conversion of MgO in the sorbent samples to its hydrates. If the calcination temperature is increased to 500° C., all the residual Mg(OH)₂ in the sorbent sample is converted to MgO, indicating the decomposition of Mg(OH)₂. This may result in the high adsorption capacities of the doped sorbent samples after 6 months of aging. The residual MgCO₃ in the doped MgO sorbent samples may form pores on the surface due to aging, promoting diffusion of CO₂ and H₂O to react with residual MgO present in the sorbent samples. This may increase CO₂ adsorption capacities when aging the sorbent sample.

### Example 5: Structural Analysis

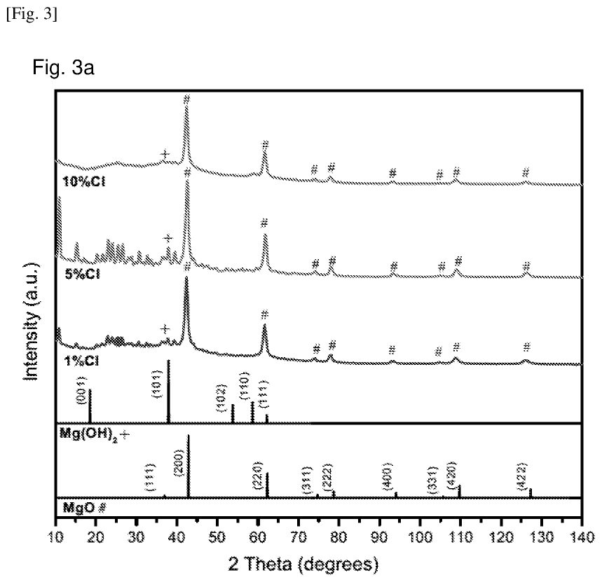

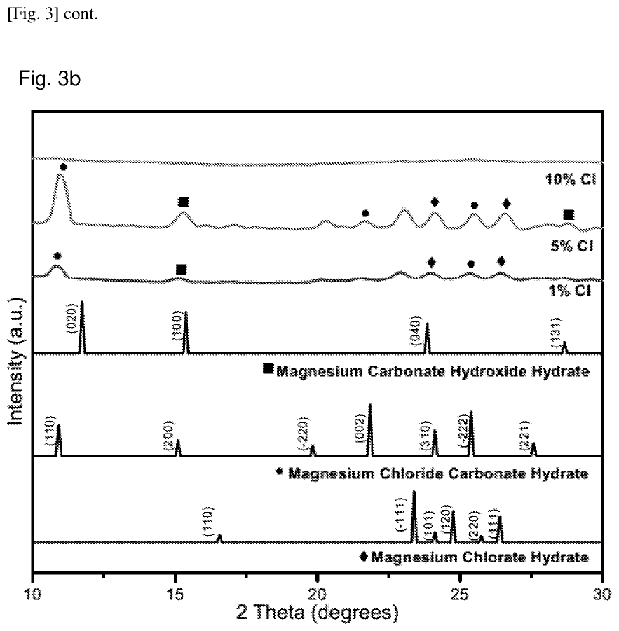

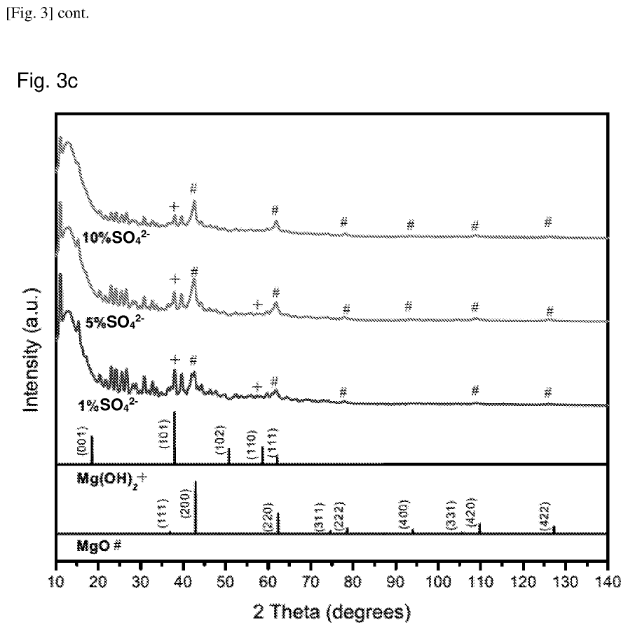

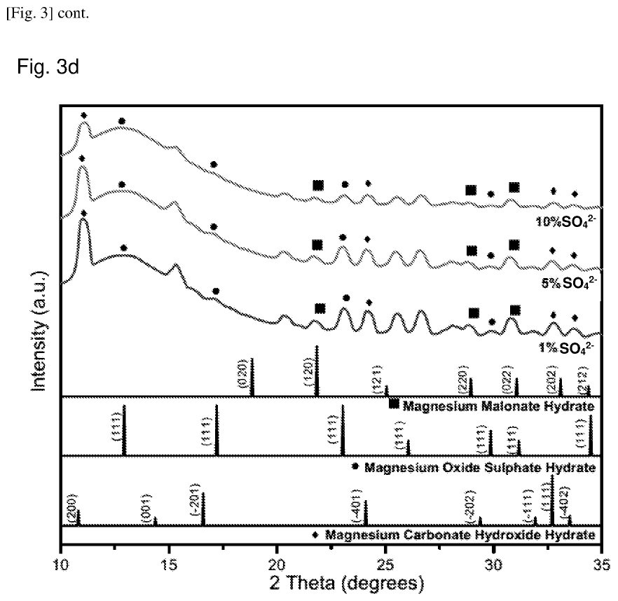

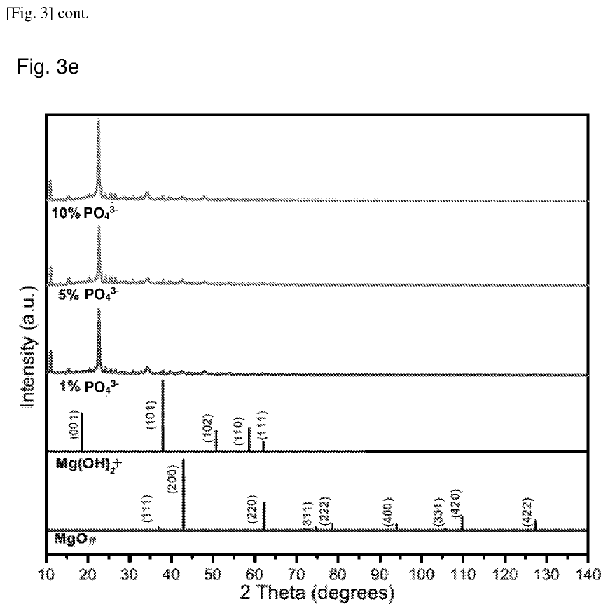

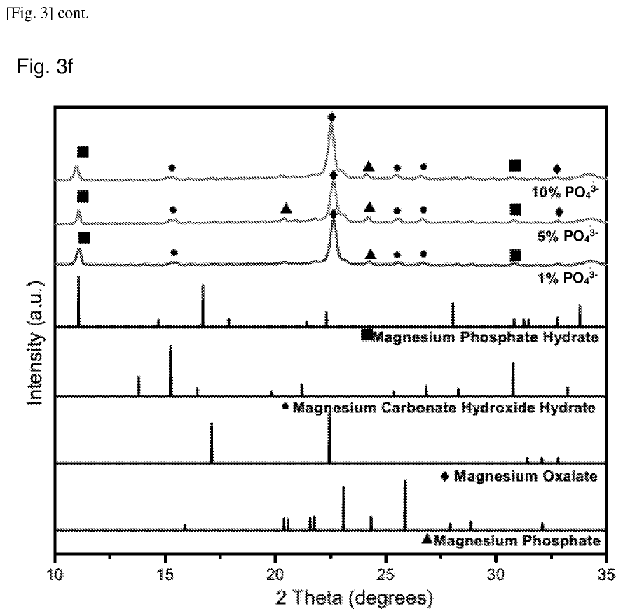

In order to investigate the chemical composition of the synthesized sorbent materials, the Cl⁻, PO₄³⁻ and SO₄²⁻ doped MgO samples which were calcinated at 300° C. were analyzed by X-ray diffraction (XRD) as shown in FIG. 3. The XRD pattern of pure MgO (ICDD 00-045-0946) and pure Mg(OH)₂ (ICDD 00-044-1482) was also provided for comparison. The main peaks of the Cl⁻ doped sorbent samples matched with characteristic peaks of MgO (111), MgO (200), MgO (220), MgO (331), MgO (222), MgO (400), MgO (420), MgO (422) and Mg(OH)₂(101) from 35° to 140° as shown in FIG. 3a. The 10° to 35° peaks mainly belonged to multiple hydrates shown in FIG. 3b. It is evident that from 2θ=10°-35° in FIG. 3b, the peaks belong to multiple hydrates of chlorine, as magnesium chlorate hydrate (Mg(ClO₄)₂·xH₂O) (ICDD 00-031-0789), magnesium chloride carbonate hydrate (Mg₂Cl₂CO₃·7H₂O) (ICDD 00-021-1254) and magnesium chloride diethylene glycol (C₈H₂₀Cl₂MgO₆) (ICDD 00-031-1763).

Based on the sharp diffraction peaks in FIG. 3a, 1% Cl⁻ doped sorbent samples appear to show better crystallinity. However, the sharpness of the peaks decreased with increasing dopant percentage, as crystallinity also declined. As the Cl⁻ percentage was increased in the sorbent samples, the characteristic peaks of the MgO shifted towards the lower angles as shown in FIG. 3a. The intensities of the hydrate peaks from 10° to 35° were visibly reduced with increasing Cl⁻ percentage as shown in FIG. 3b, indicating poor crystallinity of the samples and suggesting a systematic decrease in the grain size. This may also be due to size difference of the doped atoms in the sorbent samples, causing the crystal structure to expand or contract. However, the low intensity and large width of the peaks of the doped MgO samples indicated poor crystallinity, which may suggest a MgO—Mg(OH)₂ structure that has many defects and is amorphous-like.

Further chemical equilibria calculations were carried out with FactSage for the Cl⁻ doped sorbent samples at 10%, 5% and 1% wt MgCl₂ levels at a temperature of 300° C.

FactSage is a commercial chemical equilibrium calculation system that predicts/calculates the chemical equilibria at a given process condition such as temperature, pressure and the chemistry of initial reagents. The calculations may help to determine the chemical reactions of Cl⁻ doped systems, and thus the role of the Cl dopants in the sorbent.

$$( 1 ) 10 \% wt {MgCl}_{2} 1.543 ( mol ) {Mg ( OH )}_{2} + 0.1 \; 05 ( mol ) {MgCl}_{2} + 1 ( mol ) {H}_{2} O + 1 ( mol ) {CO}_{2} = 1.44 ( mol ) MgO + 0.21 ( mol ) Mg ( OH ) Cl + gas phase \qquad equation ( 2 )$$

$$( 2 ) 5 \% wt {MgCl}_{2} {MgC1}_{2} 1.629 ( mol ) {Mg ( OH )}_{2} + 0.053 ( mol ) {MgCl}_{2} + 0.1 \; 04 ( mol ) {H}_{2} O + 0.1 \; 04 ( mol ) {CO}_{2} = 1.579 ( mol ) MgO + 0.102 ( mol ) Mg ( OH ) Cl + 0.0001 {MgCO}_{3} + gas phase \qquad equation ( 3 )$$

$$( 3 ) 1 \% wt {MgC1}_{2} 1.698 ( mol ) {Mg ( OH )}_{2} + 0.011 {MgCl}_{2} + 0 \text{.112} {H}_{2} O + 0.1 \; 12 ( mol ) {CO}_{2} = 1.688 ( mol ) MgO + 0.018 ( mol ) Mg ( OH ) Cl + 0.0008 {MgCO}_{3} + gas phase \qquad equation ( 4 )$$

The CO₂ threshold (at an equal CO₂ to H₂O ratio) for the formation of MgCO₃ for the 10%, 5% and 1% wt MgCl₂ doped samples was respectively >1.0, 0.104, and 0.112 (moles) for a 100 gram sample. Based on equation (1), no MgCO₃ was formed even when 1 mole CO₂ was added to the 10% wt MgCl₂ doped sample, but MgCO₃ was formed for 5% wt and 1% wt MgCl₂ doped samples.

Therefore, it is unlikely that MgCO₃ is stable in samples having 10% wt MgCl₂ and 90% Mg(OH)₂ whereas the MgCO₃ is stable in the 5% wt and 1% wt MgCl₂ samples, because of the much lower (<<0.5 atm) CO₂ level in air.

It is interesting that based on thermodynamic calculation, the 5% wt Cl⁻ doped sorbent sample had the lowest CO₂ threshold and therefore the largest CO₂ concentration gap with refer to the CO₂ level in air, which correlated well with the heights of the glass phase XRD peaks from 10° to 40° (2θ).

To further investigate whether hydrates form in the 5% wt Cl⁻ doped sorbent sample at 25° C., the following calculation was performed:

$$( 4 ) 5 \% wt {MgCl}_{2} 1.629 ( mol ) {Mg ( O H )}_{2} + 0.053 ( mol ) {MgCl}_{2} + 0.104 ( mol ) {H}_{2} O + 0.00 \; 0001 ( mol ) {CO}_{2} = 1.603 ( mol ) {Mg ( OH )}_{2} + 0.0 \; 53 ( mol ) Mg ( OH ) Cl + 0.0001 {MgCO}_{3} + 0.026 {{MgCl}_{2} ( {H}_{2} O )}_{4} + gas phase \qquad ( 4 )$$

A new hydrate phase, MgCl₂(H₂O)₄, was formed at 25° C., which supported the assumption that the hydrate glass phases may be represented by the XRD peaks from 10° to 40° (2θ)). Therefore, based on thermodynamics, it was evident that hydration was a competitive process to CO₂ adsorption.

In FIG. 3c, the SO₄²⁻ doped sorbent samples showed a similar pattern to that of the Cl⁻ doped MgO—Mg(OH)₂ samples, and as the percentage of SO₄²⁻ increased, the CO₂ adsorption also increased. Although the peaks related to MgO had a low intensity, peak shift was observed in MgO (111), MgO (200), MgO (220), MgO (331), MgO (222), MgO (400), MgO (331), MgO (420), MgO (422) and Mg(OH)₂ (101) similar to the Cl⁻ doped sorbent samples. Peak intensities of the samples were low due to glass formation in the samples during calcination at 300° C. From 2θ=10°-35° the peaks indicate the presence of multiple hydrates as magnesium carbonate hydroxide hydrate (Mg₂CO₃(OH)₂·3H₂O) (ICDD 00-006-0484), magnesium oxide sulphate hydrate (Mg₆O₅SO₄·8H₂O) (ICDD 00-008-0280), and magnesium malonate hydrate (C₃H₂MgO₄·2H₂O) (ICDD 00-026-1851) as shown in FIG. 3d. Peak shift was observed with increasing percentage of the SO₄²⁻ dopant in the sorbent sample, which was due to formation of hydrates.

The PO₄³⁻ doped sorbent samples showed poor sample correlation with MgO in comparison with Cl⁻ doped sorbent samples and SO₄²⁻ doped sorbent samples, as shown in FIG. 3e. However, they also showed multiple phases such as magnesium phosphate (Mg₃(PO₄)₂) (ICDD 01-075-1491), magnesium phosphate hydrate (Mg₃(PO₄)₂· 22H₂O) (ICDD 00-044-0775), magnesium carbonate hydroxide hydrate (Mg₅(CO₃)₄(OH)₂(H₂O)₄) (ICDD 01-070-0361) and magnesium oxalate (MgC₂O₄) (ICDD 00-026-1222), showing correlation with the samples as shown in FIG. 3f. The XRD spectrum of PO₄³⁻ doped sorbent samples, which were doped with 1% wt, 5% wt, and 10% wt Mg₃(PO₄)₂, indicated the dissolution of both MgO and Mg(OH)₂ phases and the formation of magnesium oxalate (MgC₂O₄) and magnesium phosphate hydrate (Mg₃(PO₄)₂·22H₂O). It was evident from the XRD analysis that the tendency of hydrate formation increased in order of Cl⁻, SO₄²⁻ to PO₄³⁻ doping, as shown in FIG. 3b, FIG. 3d and FIG. 3f.

### Example 6: Surface Analysis

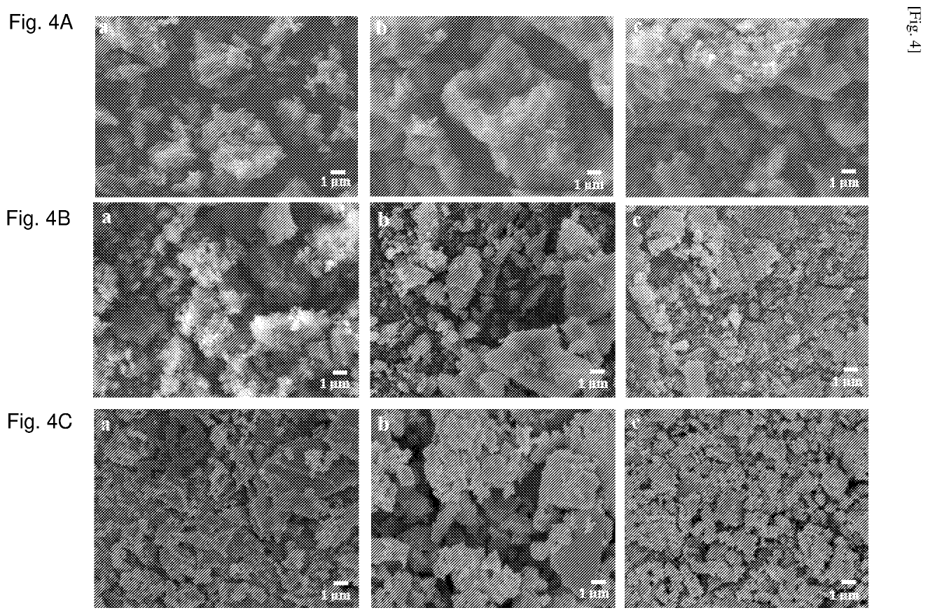

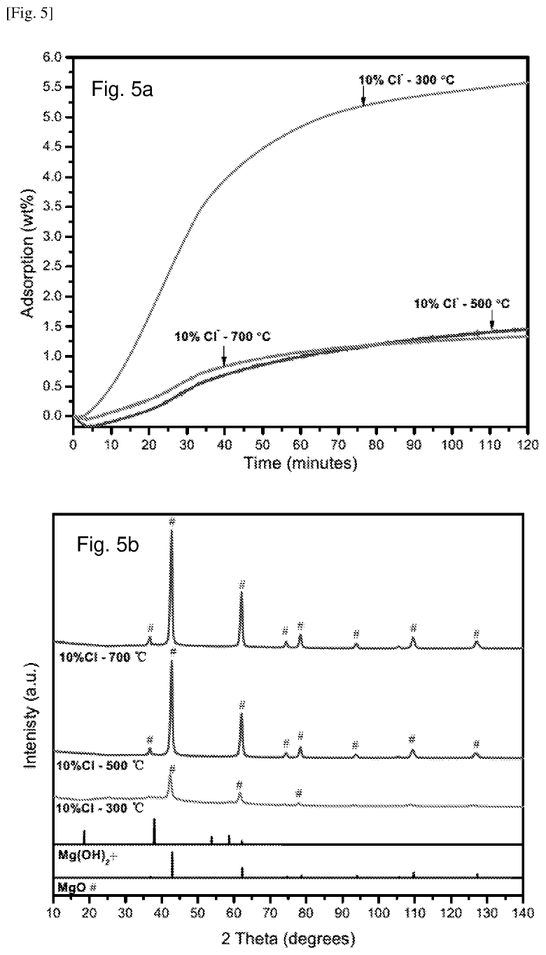

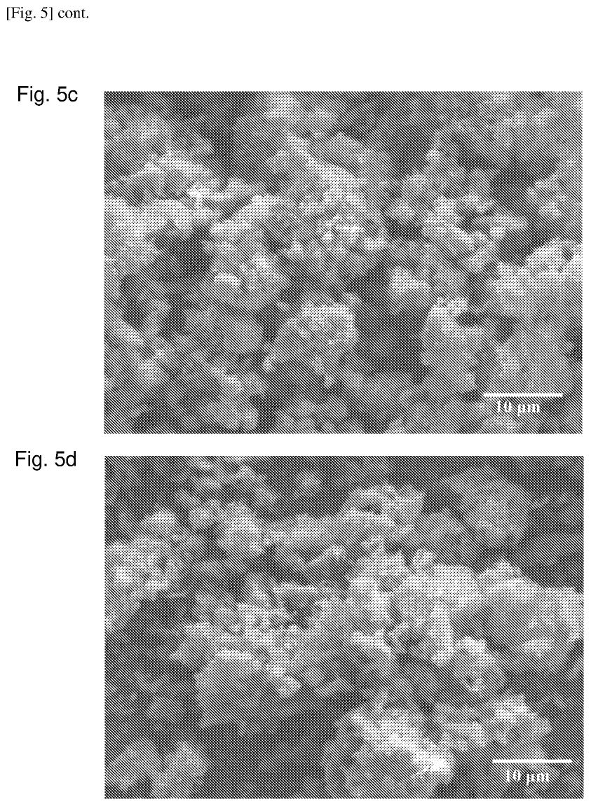

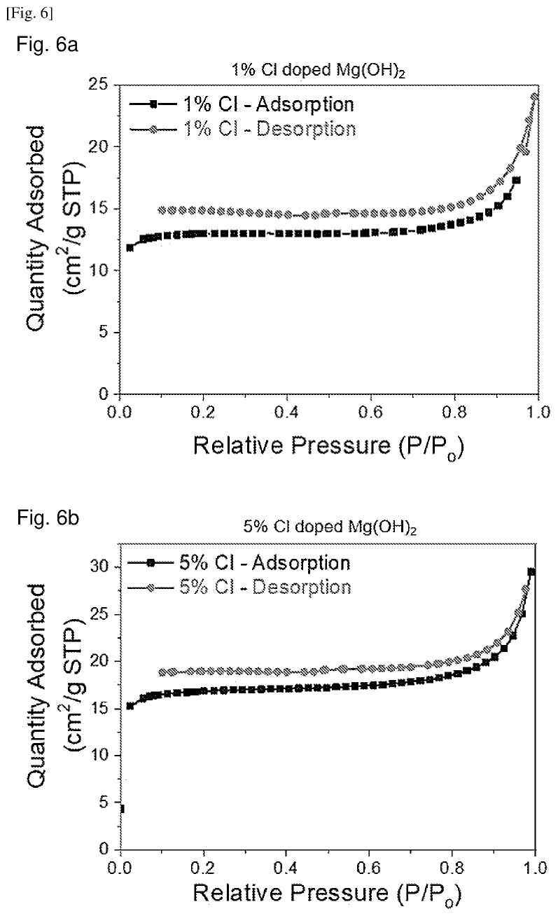

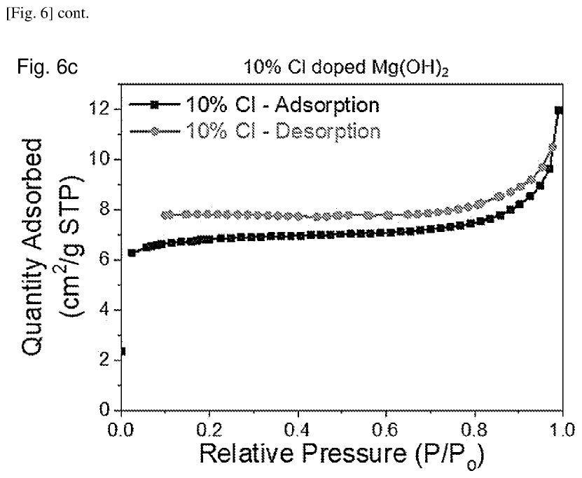

The surface morphologies of the sorbent samples were investigated with scanning electron microscopy (SEM) (JEOL JSM-7600F), using a voltage of 5 kV and a working distance of 8 mm as shown in FIG. 4, FIG. 5 and FIG. 6. The samples were ground after calcination and gold sputtered before analysis. The 1%, 5% and 10% Cl⁻ doped MgO samples were calcinated at 300° C. for 2 hours as shown in FIG. 4. The 1% Cl⁻ sorbent sample displayed a few fractured rod-like structures. The formation of rods indicated a 1-dimensional heterogeneous growth of MgO.

The 5% Cl⁻ doped MgO sample displayed sheet-like structures with uniform surfaces, having a typical 2-dimensional diffusion mode. The 10% Cl⁻ doped MgO sample showed a similar structure to the 5% Cl⁻ doped MgO sample, having a sheet-like uniform structure. The changes in morphology observed as the dopant concentration was increased from 1, 5 and 10% wt Cl⁻, were similar to that observed for MgO grown from Mg(OH)₂ using different alkali salts.

SO₄²⁻ doped MgO samples displayed sheet-like structures after calcination for 2 hours at 300° C. As SO₄²⁻ concentration was increased, the observed grain size decreased, which was consistent with previous observations that the loss of water during the decomposition of Mg(OH)₂ resulted in the formation of a porous structure, which fills up with growth of newly formed MgO particles.

PO₄³⁻ doped MgO samples also showed sheet-like structures under similar conditions, indicating a strong presence of heterogeneously grown hydrates. The morphology of the PO₄³⁻ doped MgO samples were observed to be different than that of the Cl and SO₄²⁻ doped MgO samples, due to the disappearance of the MgO phase, which may be the reason for their much lower CO₂ adsorption capacity among the 3 dopants tested. All the samples showed a sheet size of 1-3 μm.

### Example 7: Influence of Calcination Temperature

The 10% Cl⁻ doped sorbent sample was further evaluated for the influence of calcination temperature on CO₂ adsorption at room temperature. The 10% Cl⁻ doped sorbent sample was calcinated at 500° C. in a box furnace (Anhui Haibei Import & Export Co., Ltd., 1100 model, Hefei, Anhui, China). During the calcination, the furnace temperature was increased from 30° C. to 500° C. with a heating rate of 2° C./minute, and was then kept at 500° C. for 2 hours, followed by air cooling to room temperature. TGA analysis was subsequently performed to record the CO₂ adsorbing capacity using the same procedure indicated in Example 1. The same procedure for calcination and TGA analysis was repeated for a sample calcinated at 700° C. The sample calcinated at 500° C. and 700° C. showed a CO₂ adsorption capacity of 1.4 wt % and 1.33 wt %, respectively, within 1.5 hours, which was a low adsorption value compared to the 5.59 wt % of the same sample calcinated at 300° C. shown in FIG. 5a.

This significant decrease in CO₂ adsorption capacity with an increase in calcination temperature may be related to the dissolution of the designed CO₂-philic MgO and CO₂-phobic Mg(OH)₂ interfaces, along with the disappearance of the Mg(OH)₂ phase at a high calcination temperature of 500° C. and above, as shown in their respective XRD spectra in FIG. 5b.

The XRD analysis of the sorbent samples showed the main 2θ peaks of MgO (ICDD 00-045-0946) to be 36.74, 42.72, 62.06, 74.33, 78.35, 93.70, 105.33, 109.36, and 126.65, which were consistent with MgO (111), MgO (200), MgO (220), MgO (331), MgO (222), MgO (400), MgO (331), MgO (420), and MgO (422), suggesting that the formation of MgO may have caused a slight shift towards the lower angles indicated in FIG. 4b. This may be due to the possible lattice stresses caused when balancing out the stresses at the grain boundaries. In addition, by incorporating another atom in the form of a dopant such as Cl⁻, may have led to atomic radius substitutions into the atom vacancies in the lattice, which may again cause the shift in all the peaks towards the lower angles.

The sample calcinated at 500° C. showed high intensity peaks compared to the sample calcinated at 300° C., suggesting better crystallinity in the sorbent sample calcined at 500° C. Morphology of the 10% Cl⁻ doped sorbent samples calcinated at 500° C. (FIG. 5c) and 700° C. (FIG. 5d) showed similarities in structure, showing hierarchical structures with an average particle size of 1 μm. After calcination at 500° C. and 700° C., peaks related to hydrates and Mg(OH)₂ disappeared and the sample was now fully converted to MgO.

### Example 8: Surface Area Analysis

To clarify the performance of the Cl⁻ doped MgO/Mg(OH)₂ samples, the samples were thoroughly characterized using BET analysis. The specific surface area of the Cl⁻ doped MgO samples were calculated using the BET method.

A summary of surface areas is shown in Table 2, where the 5% Cl⁻ doped MgO sample showed a higher specific surface area of 65.53 m²g⁻¹ compared to the other sorbent samples. Although the 10% Cl⁻ doped MgO sample had a higher CO₂ capture capacity as discussed in Example 4, it was also shown to have the lowest specific surface area of 26.18 m²g⁻¹.

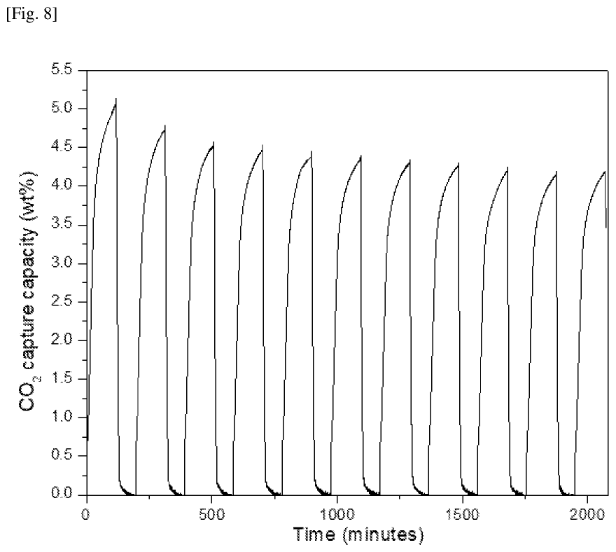

The adsorption-desorption curves of the Cl⁻ doped sorbent samples are shown in FIG. 8. The 5% Cl⁻ doped sorbent sample had the maximum hydrate phases (2 theta angles from 10°-35° in FIG. 3b) which was supported by the BET measurement.

TABLE 2
BET surface area of Cl doped MgO samples.

| | BET Surface Area |
|---|---|
| Sample | (m²g⁻¹) |
| 1% Cl | 50.35 ± 0.74 |
| 5% Cl | 65.53 ± 1.03 |
| 10% Cl | 26.19 ± 0.38 |

### Example 9: Gas Sensing Test

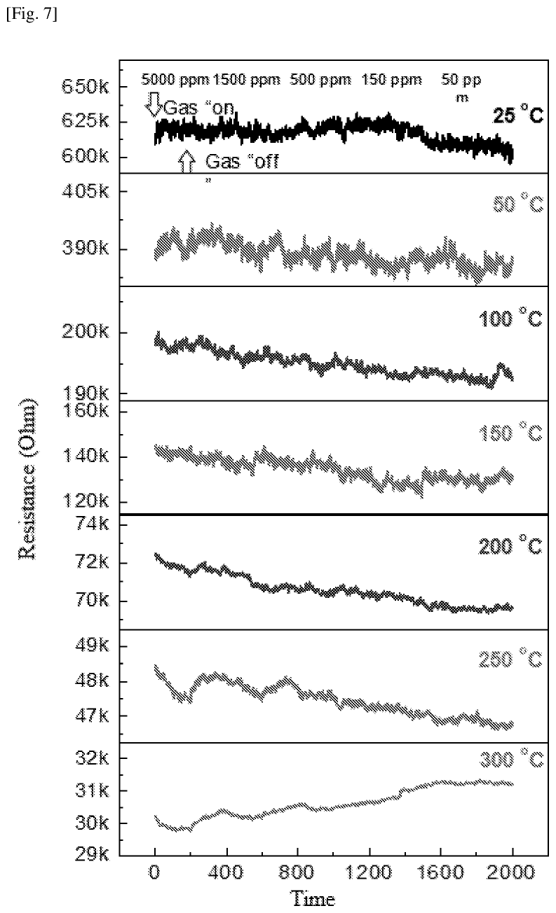

Gas sensing test was carried for the Cl⁻ doped sorbent sample which recorded the highest surface area, the 5% Cl⁻ doped MgO sample, and the results are shown in FIG. 7 and Table 3. As shown in Table 2, 5% Cl⁻ doped sorbent samples had a higher BET surface area compared to other Cl⁻ doped samples. FIG. 7 and Table 3 confirmed that the 5% Cl⁻ doped sorbent sample had a gas sensing ability at 200 to 300° C.

TABLE 3
CO₂ gas sensing data at different sensing temperatures
for the 5% Cl⁻ doped MgO sample

| CO₂ gas | 5000 ppm | 1500 ppm | 500 ppm | 150 ppm | 50 ppm |
|---|---|---|---|---|---|
| 200° C. | 1.017 | 1 | 1 | 1 | 1 |
| 250° C. | 1.022 | 1.014 | 1 | 1 | 1 |
| 300° C. | 1.013 | 1.009 | 1.006 | 1 | 1 |

The Cl⁻ doped sorbent samples were found to be a poor CO₂ sensing material at room temperature, due to the chemisorption of CO₂.

The measurement at 300° C. detected CO₂ at 500 ppm levels because the thermal decomposition temperature (to MgCO₃) is about 327° C.

### Example 10: Adsorption-Desorption Analysis

To further analyse the sorbent samples, adsorption/desorption cycles were carried out on 10% Cl⁻ doped sorbent samples, and the results are shown in FIG. 8. It was found that the CO₂ uptake at 30° C. for the 10% Cl⁻ doped sorbent sample decreased from 5.12 to 4.19 wt % over 10 cycles at 30° C., which proved that the sorbent had a good long-term adsorption/desorption stability. It was previously reported that (Li, Na, K)NO₃—MgO sorbents showed a decrease in adsorbing capacity from 16.8 to 3.2 mmol·g⁻¹ over 20 cycles. It was also previously reported that CO₂ uptake of (Li, K)NO₃—(Na, K)₂CO₃—MgO sorbents dramatically dropped by 45% after 30 cycles. In comparison, the 10% Cl⁻ doped sample disclosed herein, showed a drop rate in CO₂ adsorption of only about 18% over 10 adsorption/desorption cycles at 30° C., indicating a better cycle stability at room temperature.

The adsorption/desorption curves showed that even though a large number of hydrates were present in the 10% Cl⁻ doped sample, it was stable at 30° C. Therefore, the presence of the hydrates may enhance the performance of the Cl⁻ doped sorbent materials.

### Example 11: Iso-Diagonality

It is well known that iso-diagonality is an important feature when considering properties of chemical substances. Phosphorus, sulfur and chlorine are iso-diagonal partners in period 3 of the Periodic Table of Elements, where both phosphorus and sulfur are multivalent nonmetals and chlorine is a monovalent nonmetal. All three of these elements form van der Waals bonds. In recent times, the diagonal properties have come into light as most cases of iso-diagonality involve covalently bonded species. The electronegativity of these elements is in the order of phosphorus<sulfur<chlorine. The electronegativities of carbon and phosphorus are very similar, i.e 2.05 and 2.06, respectively. The non-polar nature of the carbon-phosphorus bond results in the ability of phosphorus to replace carbon with insignificant changes in chemical reactivity. However, the electronegativity of sulfur (2.44) and chlorine (2.83) are closer to carbon than nitrogen (3.07) and oxygen (3.05). This may be the reason why the Cl⁻ doped sorbent samples outperformed the PO₄⁻³ and SO₄⁻² doped sorbent samples, while the SO₄⁻² and PO₄⁻³ doped sorbent samples performed similarly to each other in terms of CO₂ adsorption.

### Comparative Example

The following Table 4 summarizes the previously known works on using MgO for CO₂ capture, in comparison with the sorbent of the present disclosure.

TABLE 4
Room temperature CO₂ capture capacities of MgO based adsorbents
compared with 10% Cl⁻ doped sample disclosed herein.

| | | | | CO₂ |
|---|---|---|---|---|
| | | | Sorption | Capture |
| | | Synthesis | Temperature | Capacity |
| Example | Material | Method | (° C.) | (wt %) |
| Present Sorbent | MgO/5% Cl⁻ | Electrospinning | 30 | 13.95 |
| Comparative 1 | MgO/TiO₂ | Sol-gel process | 25 | 0.47 |
| Comparative 2 | MgO | solution- | 25 | 1.611 |
| | | combustion | | |
| | | process and Ball | | |
| | | milling | | |
| Comparative 3 | MgO | Template method | 25 | 8 |
| Comparative 4 | MgO | Electrospinning | 30 | 3.9 |
| Comparative 5 | MgO— | Sol-gel synthesis | 30 | 4.9 |
| | Tetraethylenepentamine | | | |
| | (TEPA) | | | |
| Comparative 6 | MgO | Aerogel method | 30 | 10.3 |
| Comparative 7 | MgO/CeO₂ | Sol-gel | 30 | 10.4 |
| | | combustion | | |
| | | method | | |
| Comparative 8 | MgO/CuO | Sol-gel and wet | 40 | 5.0 |
| | | chemical | | |
| | | technique | | |

### INDUSTRIAL APPLICABILITY

The material as defined above may be used in CO₂ adsorbing devices, gas separation equipment, post- and pre-combustion CO₂ capture, CO₂ recovery and storage, catalysis, interconversion of hydrocarbons, natural gas purification, biogas upgrading, building materials including cement materials, fuel synthesis and in CO₂ sensors.

The material as defined above may also be suitable for use in coastal protection engineering, to adapt to rising sea levels and acidification of sea water due to CO₂ adsorption. Similarly, the material as defined above may be suitable for use in adsorbing CO₂ from wastewater.

The material as defined above may be used to desorb CO₂, which may be suitable for use in regulating CO₂ concentrations both indoor and outdoors, as well as facilitating organism growth, for example in a marine environment.

The carbon captured by the material as defined above may also be used in the manufacture of carbon products such as carbon nanotubes and carbon powders, thereby making the material as defined above valuable for sourcing carbon.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A material comprising an anion-doped alkaline earth metal oxide.

2. The material according to claim 1, wherein the alkaline earth metal is selected from the group consisting of Mg, Ca, Sr, Ba and any mixture thereof.

3. The material according to claim 1, wherein the anion is selected from the group consisting of halide, sulfate, nitrate, phosphate and any mixture thereof.

4. The material according to claim 1, further comprising water.

5. The material according to claim 1, wherein the material is in the form of nanofibers, flakes, rods, sheets or any mixture thereof.

6. A method for preparing the material of claim 1, comprising the step of contacting a hydroxide salt of an alkaline earth metal with a second salt of the alkaline earth metal.

7. The method according to claim 6, wherein the second salt of the alkaline earth metal is not the same as the hydroxide salt of the alkaline earth metal.

8. The method according to claim 6, wherein the ratio between the hydroxide salt of the alkaline earth metal and the second salt of the alkaline earth metal is in the range of about 99.9:0.1 to about 80:20 by weight.

9. The method according to claim 6, wherein the contacting step is performed in a solvent.

10. The method according to claim 9, wherein the solvent comprises acetic acid, water, or a mixture thereof.

11. The method according to claim 6, wherein the contacting step further comprises a polymer.

12. The method according to claim 11, wherein the polymer is polyvinyl acetate or polyacrylonitrile.

13. The method according to claim 11, wherein the ratio between the hydroxide salt of the alkaline earth metal and the polymer is in the range of about 1:5 to about 1:20 by weight.

14. The method according to claim 6, further comprising the step of forming the material into fibres.

15. The method according to claim 14, wherein the forming step is performed by electrospinning.

16. The method according to claim 9, further comprising the step of removing the solvent.

17. The method according to claim 6, further comprising the step of calcining the material.

18. The method according to claim 6, further comprising the step of grinding the material into a powder.

19. The method according to claim 6, further comprising the step of aging the material.

20. (canceled)

21. A method for adsorbing CO₂ from an environment, the method comprising the step of contacting the material of claim 1 with the environment.

22. (canceled)
